(19) United States
(12) Patent Application Publication
(10) Pub. No.: US 2015/0069032 A1
(43) Pub. Date: Mar. 12, 2015

(54) COMMUNICATION PORT FOR ENGINE DRIVEN WELDER

(71) Applicant: LINCOLN GLOBAL, INC., CITY OF INDUSTRY, CA (US)

(72) Inventor: SAMIR FARAH, BROADVIEW HEIGHTS, OH (US)

(73) Assignee: LINCOLN GLOBAL, INC., CITY OF INDUSTRY, CA (US)

(21) Appl. No.: 14/091,504

(22) Filed: Nov. 27, 2013

Related U.S. Application Data
(60) Provisional application No. 61/876,794, filed on Sep. 12, 2013.

(51) Int. Cl. B23K 9/10

(52) U.S. Cl. CPC B23K 9/1006; B23K 9/1081
USPC 219/133

(57) ABSTRACT

The invention described herein generally pertains to a system and method for including a port component to an engine driven welding device. An engine driven welding device includes a motor that is a power source for a welding operation, wherein a first circuit converts a voltage from the power source to a second voltage. A port component utilizes the second voltage as a power source for an external device. Additionally or alternatively, the port component utilizes the second voltage to power a data transfer between the external device and the engine driven welding device.

### CROSS-REFERENCE TO RELATED APPLICATIONS

This application claims the benefit of priority to U.S. Provisional Application Ser. No. 61/876,794, filed Sep. 12, 2013, and entitled “PORT COMPONENT FOR ENGINE DRIVEN WELDER.” The entirety of the aforementioned application is incorporated herein by reference.

### TECHNICAL FIELD

The invention described herein pertains generally to a system and method that incorporates a port component with an engine driven welder, and in particular, a port component that provides communication and/or power supply for an external device or component.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Static powered welders initiate the weld process by way of a trigger on a hand-held torch or with an electrically charged stick connected to a charged electrode.

Rotating power driven welders operate similarly, as long as the engine is running. If the engine is shut down, there is typically no residual power to create an arc. To once again weld, the engine must be started and run at operational speed to produce the arc. Therefore, it is simply not possible to manually start and stop the engine between each and every break in the welding process. Further, even during longer periods, operators may find it easier to let the engine run because of distance to the engine, a misconception that it is better for the engine, or just out of habit.

### SUMMARY OF THE INVENTION

In accordance with the present invention, there is provided a welding device that includes a motor-driven welder assembly including a motor that is a power source for the welding device to perform a welding operation and a first circuit that electrically isolates and converts the power source to a first voltage used for controlling the welding operation. The welding device further includes a port component that electrically isolates and converts the first voltage to a second voltage, wherein the second voltage is used as at least one of a power source for an external device or a power source to provide data communication between a portion of the welding device and the external device.

In accordance with the present invention, there is provided a method that includes at least the following steps: utilizing a motor to generate a voltage for use with a welding operation; receiving the voltage from the motor; reducing the voltage to an isolated second voltage, wherein the isolated second voltage is less than the voltage from the motor; utilizing the isolated second voltage to power a port component; electronically coupling the port component to an external device; and utilizing the port component to at least one of charge the external device or exchange data with the external device.

In accordance with the present invention, there is provided a welding device that includes at least the following: a motor-driven welder assembly including a motor that is a power source for the welding device to perform a welding operation; an energy storage device that provides a supplemental power source to the power source to perform the welding operation; a switch component that is configured to automatically switch between the motor and the energy storage device to perform the welding operation based on a welding parameter; a first circuit that electrically isolates and converts the power source or the supplemental power source to a first voltage used for controlling the welding operation; means for connecting a smartphone to the welding device; and a port component that electrically isolates and converts the first voltage to a second voltage, wherein the second voltage is used as at least one of a power source for the smartphone or a power source to provide data communication between a portion of the welding device and the smartphone.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a block diagram illustrating a welding device that includes a motor as a power source;

FIG. 2 is a block diagram illustrating a welding device;

FIG. 3 is a block diagram illustrating a welding device affixed to a trailer for mobility;

FIG. 4A is a block diagram illustrating a welding device;

FIG. 4B is a block diagram illustrating a welding device;

FIG. 5 is a block diagram illustrating a welding device that includes a port component configured to convert voltage for use with an external device;

FIG. 6 is a block diagram illustrating a hybrid welding device that incorporates connectivity to an external device for charging or data exchange;

FIG. 7 is a block diagram illustrating a welding device that includes a port component for diagnostics; and

FIG. 8 is a flow diagram of converting a voltage from a motor associated with an engine driven welder for use with a port component.

### DETAILED DESCRIPTION OF THE INVENTION

Embodiments of the invention relate to methods and systems that generally relate to converting a voltage generated by a power source of a welding device to a second voltage, wherein the second voltage is lower than the first voltage and is used with an external device. For instance, a port component can be used to connect the external device to the welding device to receive the second voltage. In another embodiment, the port component is configured to exchange data between the welding device and the external device. For example, a portion of data can be communicated and/or received between a data storage of the welding device and a data storage of the external device. In still another embodiment, the port component can provide wireless connectivity for the welding device such that the port component performs as a wireless transmitter and/or receiver.

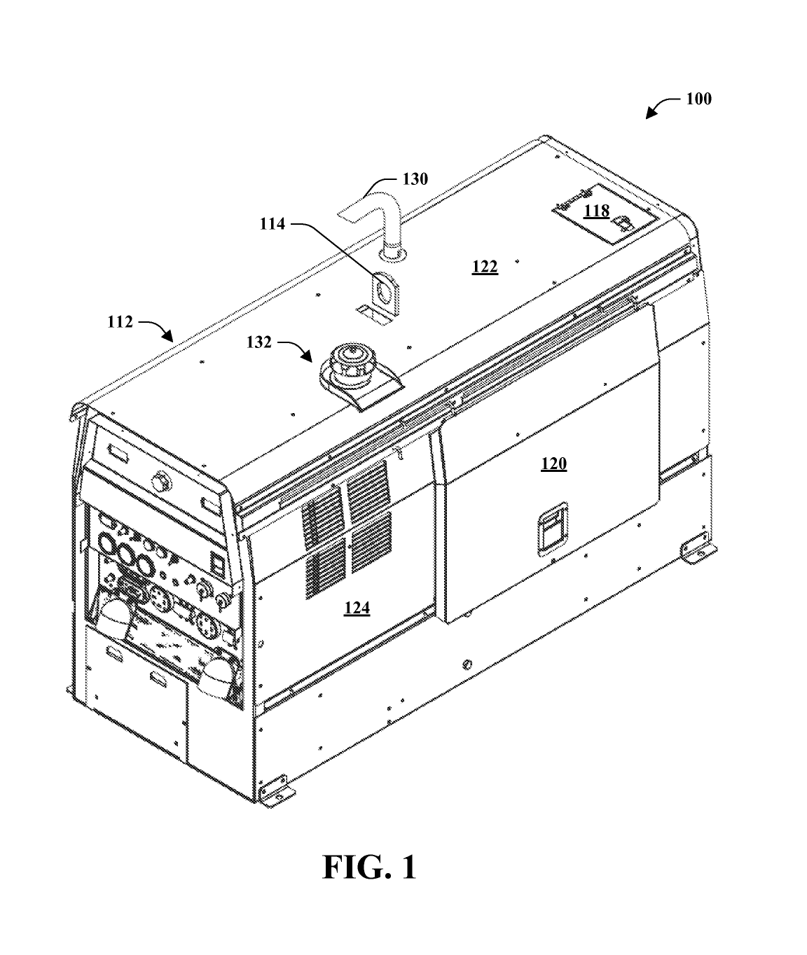

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates a welding device 100. The welding device 100 includes a housing 112 which encloses the internal components of the welding device. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel includes a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

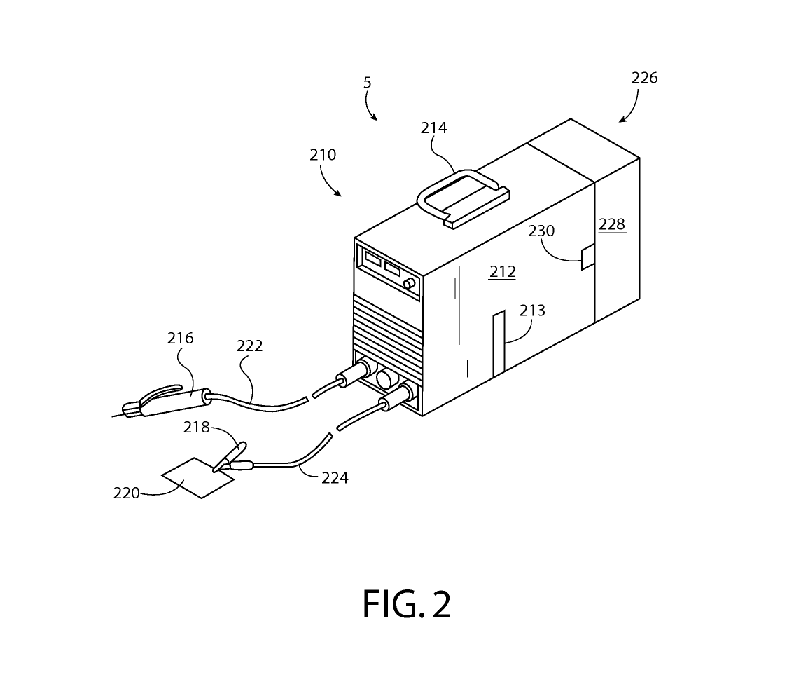

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

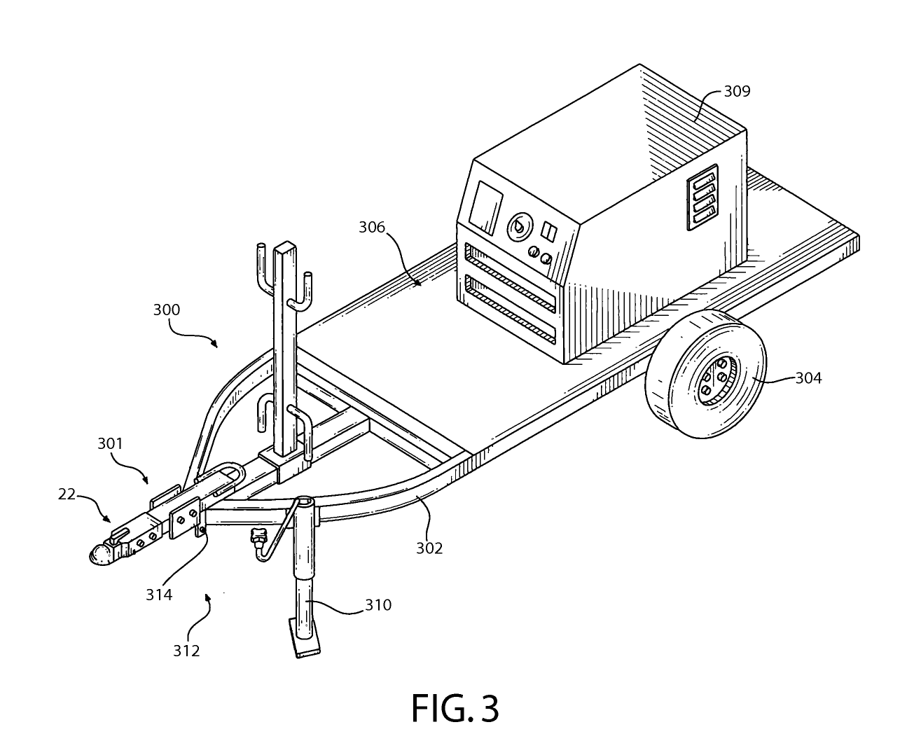

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 308 or an engine driven welding power supply 308. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

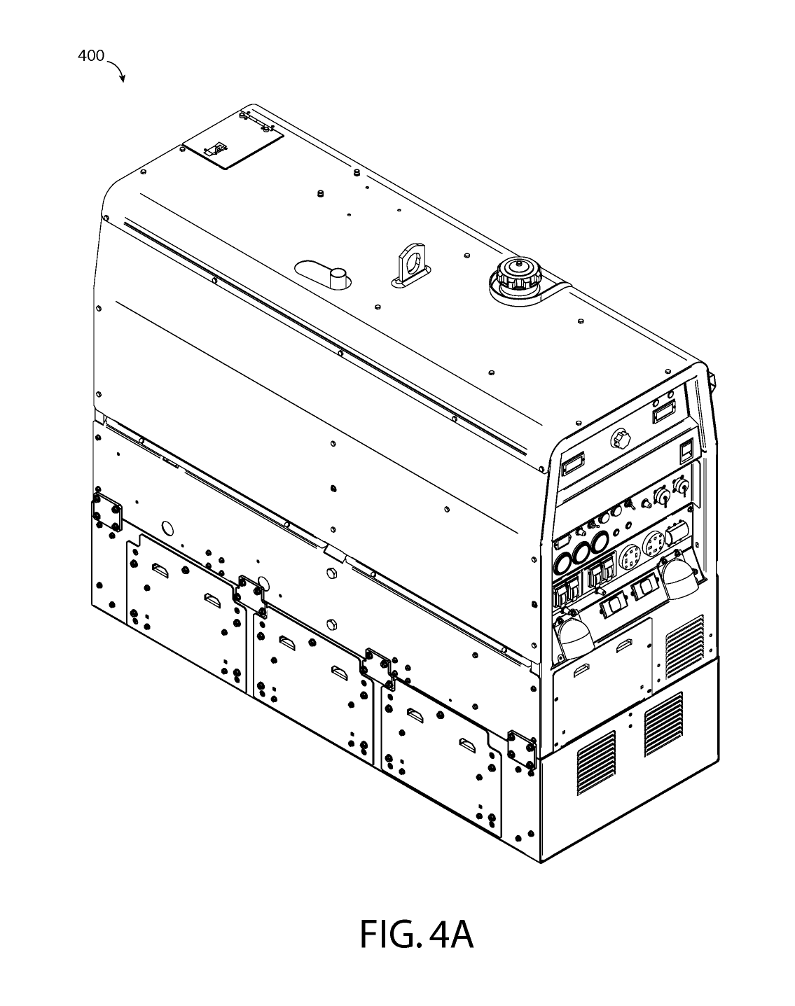

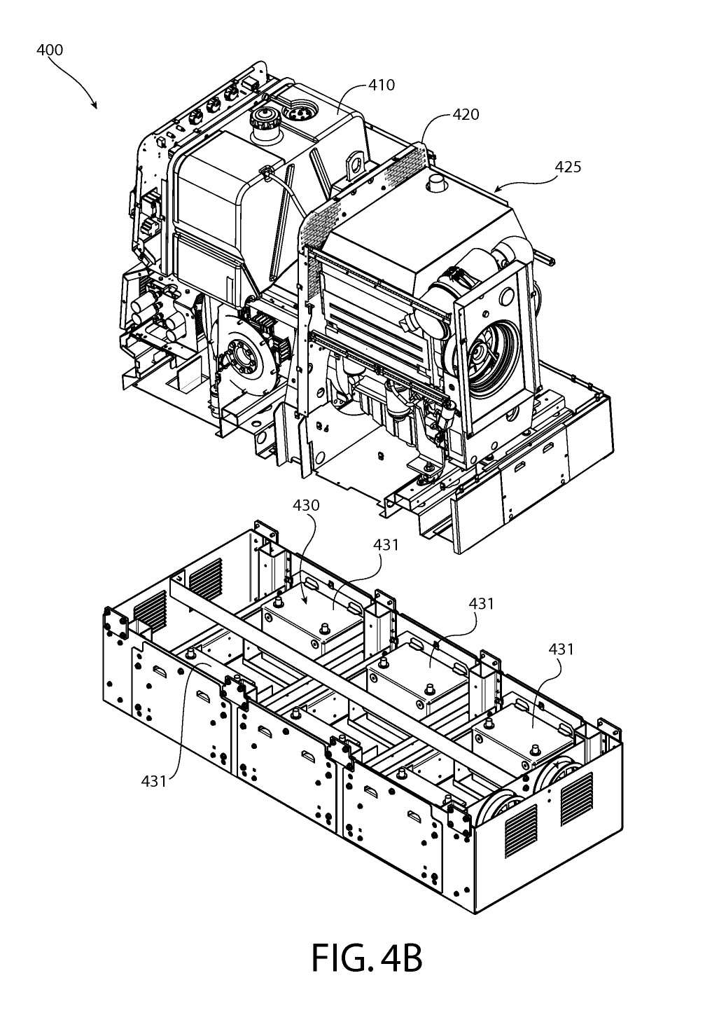

FIGS. 4A and 48 illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

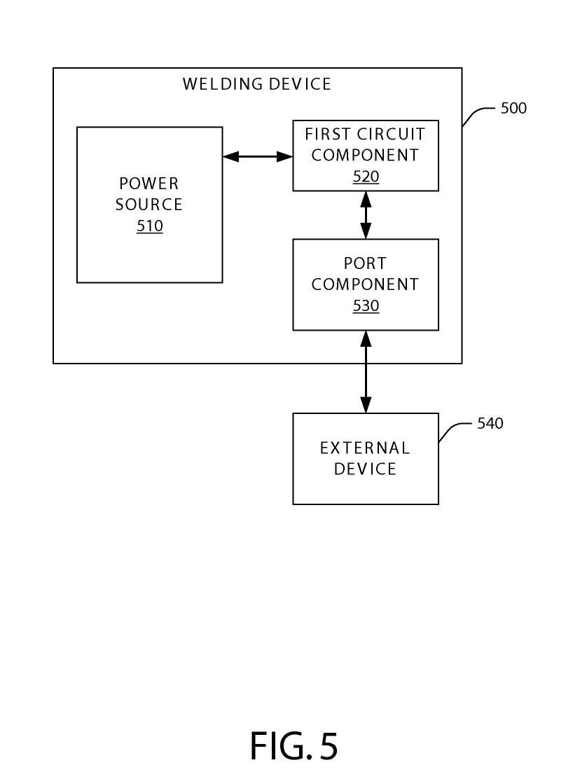

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 5-7 illustrate a schematic block diagram of a welding device, and in particular, an engine driven welding device as discussed in FIGS. 1-4.

Turning to FIG. 5, welding device 500 is illustrated that includes power source 510 that generates voltage for use with performing a welding operation. By way of example and not limitation, power source 510 can be a motor, an engine, an energy storage device, an outlet (e.g., AC/DC outlet source for voltage) configured to receive a power supply, a combination thereof, among others. It is to be appreciated that power supply 510 can be chosen with sound engineering judgment without departing from the intended scope of coverage of the embodiments of the subject invention. For instance, a power source used with an engine driven welding device can be utilized as power source 510. Power source 510 as used in the subject innovation can generate and/or convert a plurality of voltages such simultaneously or at different times. For instance, a first voltage can be generated and a second voltage can be converted from the first voltage, wherein the conversion can be after the generation of the first voltage. In another embodiment, the second voltage can be converted at the same time as the generation of the first voltage. In still another embodiment, power source 510 can generate the first voltage and the second voltage at the same time such that no conversion is provided since the first voltage and the second voltage are generated directly. It is to be appreciated that these variations of voltage generation and conversion can be provided by power source 510 as well as other power sources described herein with the subject innovation.

Welding device 500 further includes first circuit component 520 that is configured to isolate and convert the voltage generated by power source 510. For example, first circuit component 520 can include any suitable circuitry that converts a first voltage to a second voltage, wherein the first voltage is greater than the second voltage. By way of example and not limitation, first circuit component 520 can be an isolation stepdown circuit. Moreover, it is to be appreciated that first circuit component 520 can be chosen with sound engineering judgment without departing from the intended scope of coverage of the embodiments of the subject invention. For example, although welding device 500 is illustrated with first circuit component 520, any suitable number of circuits can be utilized by the subject innovation.

First circuit component 520 can be configured to isolate and convert the voltage from power source 510 into a second voltage. First circuit component 520 can further condition the second voltage so as to reduce effects from power source 510. By way of example and not limitation, conditioning can relate to a filtering of a signal, a noise reduction of a signal, isolation of a signal, and the like. For instance, a conditioning of a signal can be performed by, but not limited to, an optical coupler, a transformer, among others. Second voltage created by first circuit component 520 is utilized by port component 530, wherein port component 530 allows connectivity to external device 540 (discussed in more detail below).

The second voltage can be supplied to external device 540 by port component 530. In an embodiment, the second voltage is utilized to charge an energy storage device (not shown) associated with external device 540. In another embodiment, the second voltage is utilized to power a data exchange between external device 540 and welding device 500. In another embodiment, the second voltage is utilized to power port component 530 for data communication between external device 540 and welding device 500. By way of example and not limitation, the data communication can be wireless, wired, or a combination thereof.

For instance, a port component with a welding device can be utilized to charge a device external to the welding device, wherein the device external to the welding device can be a smartphone, a laptop, a computer, a portable digital assistant (PDA), a tablet, a portable gaming device, among others (discussed in more detail below). For instance, an energy storage device associated with the device can be charged with the second voltage converted from the power source in the welding device (as discussed above). In another example, the port component can be used as a wireless transmitter and/or receiver, wherein the port component is powered by the second voltage. For instance, the port component can receive and/or transmit data between the welding device (or data storage medium associated therewith) and the external device.

By way of example and not limitation, the external device can be a smartphone, a cellular device, a cellular phone, a tablet, a laptop, a portable digital assistant (PDA), an Internet browsing device, a Wireless Fidelity (Wi-Fi) device, a portable gaming device, a gaming device, a speaker, a headphone set, a wireless speaker, a Bluetooth device, a wireless device accessory, a data storage device, a data storage medium, a external harddrive, a harddrive, a device with a processor and memory, among others. By way of example and not limitation, the port component can be a Universal Serial Bus (USB) port, a Controller Area Network (CAN) bus, a wireless communication transmitter, a wireless communication receiver, a 12-volt charger port, a 9-volt charger port, a micro USB port, a mini USB port, a micro-A USB port, a micro-B USB port, a mini-A USB port, a mini-B USB port, a type A USB port, a type B USB port, a connector that connects the external device to the welding device and supplies the second voltage to the external device, among others.

In order to provide additional context for various aspects of the present invention, the following discussion is intended to provide a brief, general description of a suitable computing environment in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and/or software. Generally, program modules include routines, programs, components, data structures, etc., that perform particular tasks or implement particular abstract data types.

Moreover, those skilled in the art will appreciate that the inventive methods (e.g., method 800) may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices. For instance, a remote database, a local database, a cloud-computing platform, a cloud database, or a combination thereof can be utilized with the present invention.

Component(s) and/or device(s) disclosed herein can utilize an exemplary environment for implementing various aspects of the invention including a computer, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit.

When used in a LAN networking environment, component(s) and/or device(s) can be connected to the local network through a network interface or adapter. When used in a WAN networking environment, the component(s) and/or device(s) typically includes a modem, or is connected to a communications server on the LAN, or has other means for establishing communications over the WAN, such as the Internet. In a networked environment, program modules depicted relative to the component(s) and/or device(s), or portions thereof, may be stored in the remote memory storage device. It will be appreciated that network connections described herein are exemplary and other means of establishing a communications link between the component(s) and/or device(s) may be used.

Alternatively or in addition, a local or cloud (e.g., local, cloud, remote, among others) computing platform can be utilized for data aggregation, processing, and delivery. For this purpose, the cloud computing platform can include a plurality of processors, memory, and servers in a particular remote location. Under a software-as-a-service (SaaS) paradigm, a single application is employed by a plurality of users to access data resident in the cloud. In this manner, processing requirements at a local level are mitigated as data processing is generally done in the cloud, thereby relieving user network resources. The software-as-a-service application allows users to log into a web-based service (e.g., via a web browser) which hosts all the programs resident in the cloud.

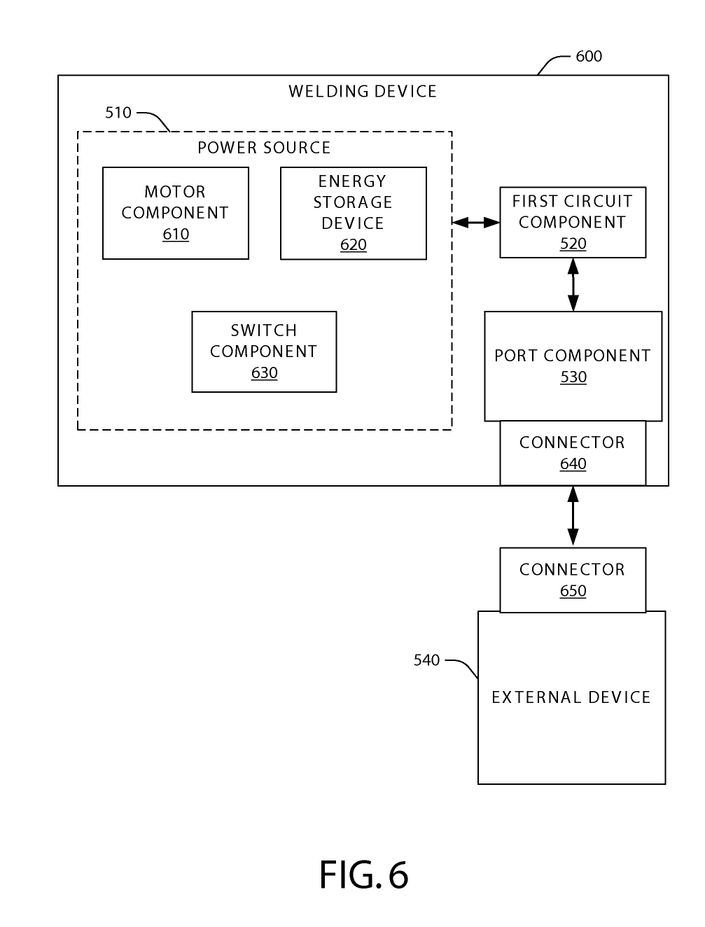

FIG. 6 illustrates welding device 600 that converts a voltage from power source 510 of the welding device to a second voltage for use with port component 530. In an embodiment, power source 510 can include a hybrid power source that includes motor component 610 and energy storage device 620. It is to be appreciated that the hybrid power source can be substantially similar to the hybrid device discussed above in FIGS. 4A and 48. For instance, motor component 610 can generate a voltage and such voltage can be stored in energy storage device 620. Switch component 630 can automatically select between motor component 610 and energy storage device 620 for a power source for the welding operation performed by the welding device 600. In an embodiment, the switch component 630 can select between motor component 610 and energy storage device 620 based upon a welding parameter.

For instance, the welding parameter can be, but is not limited to, a voltage of the welding operation, a current of the welding operation, a portion of a waveform used with the welding operation, a welding schedule parameter (e.g., welding process, wire type, wire size, wire feed speed (WFS), volts, trim, wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), an amount of fuel available for motor component 610, an amount of charge stored in energy storage device 620, a signal from a controller of the welding operation, a signal from a controller associated with welding device 600, and the like.

Switch component 630 can further manage power supply to port component 530, wherein the power supply can be from energy storage device 620 or motor component 610. The management of power supply can be based on a parameter. In an embodiment, the parameter can be related to a welding operation (discussed above), welding device 600, external device 540, or a combination thereof. For instance, switch component 630 can evaluate external device 540 to select which power source 510 to supply electrical current to external device 540. By way of example and not limitation, external device 540 can include a parameter such as a type of device, a power consumption, a wireless frequency, a voltage, a current, a make, a model, a brand, a connector (e.g., male plug, female plug, etc.), a purpose of device (e.g., diagnostic, display, upload information, download information, etc.), and the like.

For example, welding device 600 can include a circuit component (not shown) to convert voltage from motor component 610 for use with control of a welding operation on a workpiece. For instance, a hardware link board can be used to convert and isolate voltage from motor component 610 to use for the welding operation or control thereof. In such example, the hardware link board can step down voltage from motor component 610 to 40 volts. In an example, first circuit component 520 can convert the 40 volts to a second voltage that is lower than 40 volts.

For example, welding device 600 can include a circuit component (not shown) associated with energy storage device 630 that controls use of energy storage device 620 as a power source for performing a welding operation on a workpiece. For instance, the circuit component associated with energy storage device 630 can utilize a 12 volt signal. In such example, the circuit component associated with energy storage device 630 can step down voltage from motor component 610 to 12 volts. In an example, first circuit component 520 can convert the 12 volts to a second voltage that is lower than 12 volts.

Port component 530 utilizes the second voltage via first circuit component 520. As discussed above, port component 530 can be a power source for external device 540, a power source for data exchange between welding device 600 and external device 540, and/or a power source for diagnostics of welding device 600 via external device 540. Port component 530 can connect or couple with external device 540 with a hard wire connection or a wireless connection. For example, in a wireless connection or coupling, the second voltage can be used to power a transmitter and/or receiver associated with welding device 600. By way of example and not limitation, a wired connection or coupling can include one or more connectors such as connector 640 and connector 650. Connector 640 and connector 650 can be any suitable male to female connectors that allow coupling for electronic signals between welding device 600 and external device 540. For instance, any of the following port connectors can be used with port component 530 as well as connector 640 and connector 650: a Universal Serial Bus (USB) port, a micro USB port, a mini USB port, a micro-A USB port, a micro-B USB port, a mini-A USB port, a mini-B USB port, a type A USB port, a type B USB port, a socket and mating plug as defined in an ANSI/SAE J563 specification, among others.

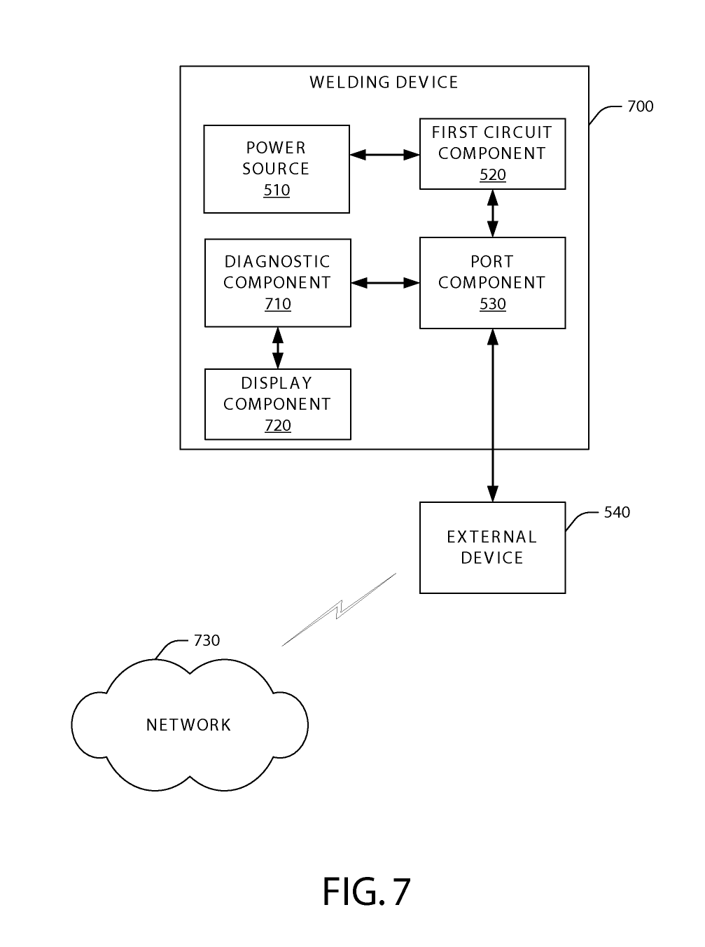

FIG. 7 illustrates welding device 700 that provides diagnostics based on connectivity between external device 540 and port component 530, wherein port component 530 is powered by a second voltage converted from power source 510. Diagnostic component 710 can aggregate data related to a condition or state of welding device 700. For instance, data collected or aggregated can be, but is not limited to, an error code, a bit stored in a memory of welding device 700, data stored on memory related to a controller of welding device 700, a data value for a variable used with a portion of code for welding device 700, a data value for a variable used with a portion of software for welding device 700, and the like.

Diagnostic component 710 can communicate data to and/or from external device 540 via port component 530. For instance, a portion of software (e.g., a widget, an application, an applet, and the like) can be hosted by external device 540 in which diagnostics of welding device 600 can be performed. In such instance, external device 540 can collect data from welding device 700 and communicate such data for evaluation and/or troubleshooting. In an embodiment, a portion of software hosted by external device 540 can generate an instruction to facilitate remedying the condition or the state of welding device 700. Moreover, display component 720 can provide a graphical image to communicate one or more instructions generated. For instance, display component 720 can be incorporated into welding device 700 (as depicted), a stand-alone component, incorporated into external device 540, or a combination thereof.

In an embodiment, external device 700 can communicate such data via network 730 to receive one or more instructions to remedy the condition or state of welding device 700. For instance, the one or more instructions can be, but are not limited to, a user input on welding device 700, an adjustment to a setting on welding device 700, a restart of motor component (not shown) of welding device 700, an adjustment to a fluid (e.g., combustible fuel, oil, and the like) related to the motor of welding device 700, a maintenance on welding device 700, or a replacement of a component of welding device 700.

In an example, data can be collected by diagnostic component 710 based on a state or condition of welding device 700. For instance, based on a failure or an error of welding device 700, an error code can be data collected or aggregated by diagnostic component 710. Based on such data, a notification or alert can be generated via display component 720 or other suitable manner (e.g., visual alert, audible alert, and the like). A smartphone (e.g., external device 540) can be used to download a portion of software for welding device 700 that allows diagnostics. The smartphone can connect to welding device 700 via port component 530 and based on such coupling and connectivity, the error code can be received. The smartphone can evaluate the error code locally, remotely (e.g., via network 730), or a combination thereof. Based on the evaluation of the error code, one or more instructions can be identified that can troubleshoot and aim to remedy the condition or state of welding device 700. The one or more instructions can be displayed or communicated via a display associated to external device 540, welding device 700, or a combination thereof. In one embodiment, a visual presentation of step-by-step instructions can be displayed that are instructions on how to remedy the condition or state of welding device 700 that initiated the error or failure.

In an embodiment, the welding device include an energy storage device that is an additional power source for the welding device to perform the welding operation; and a switch component that selects between the energy storage device and the motor. In the embodiment, the port component electrically isolates and converts the additional power source to the second voltage. In an embodiment, the port component is a female connector that is configured to receive a male connector for the external device to provide electrical connectivity therebetween for at least one of power exchange or data communication. In an embodiment, port component provides the second voltage to an energy storage device of the external device.

In an embodiment, the port component is at least one of a Universal Serial Bus (USB) port, a Controller Area Network (CAN) bus, a wireless communication transmitter, a wireless communication receiver, a 12-volt charger port, a 9-volt charger port, a micro USB port, a mini USB port, a micro-A USB port, a micro-B USB port, a mini-A USB port, a mini-B USB port, a type A USB port, or a type B USB port. In an embodiment, the first voltage is between 35 volts and 45 volts and the second voltage is between 4 volts and 14 volts. In the embodiment, the first voltage is approximately 40 volts and the second voltage is approximately 5 volts, 9 volts or 12 volts. In the embodiment, the first voltage is approximately 12 volts and the second voltage is approximately 5 volts or 9 volts.

In an embodiment, the welding device can include a diagnostic component that communicates with the external device to at least one of receive or transmit a portion of data related to a condition of the welding device. In the embodiment, the diagnostic component communicates with a portion of software hosted by the external device. In an embodiment, the diagnostic component generates an instruction, that is based on the portion of data, to mitigate the condition of the welding device. In the embodiment, the instruction is at least one of a user input on the welding device, an adjustment to a setting on the welding device, a restart of the motor of the welding device, an adjustment to a fluid related to the motor of the welding device, a maintenance on the welding device, or a replacement of a component of the welding device.

In an embodiment, the external device is a smartphone. In an embodiment, the external device is at least one of a cellular device, a cellular phone, a tablet, a laptop, a portable digital assistant (PDA), an Internet browsing device, a Wireless Fidelity (Wi-Fi) device, or a device with a processor and memory.

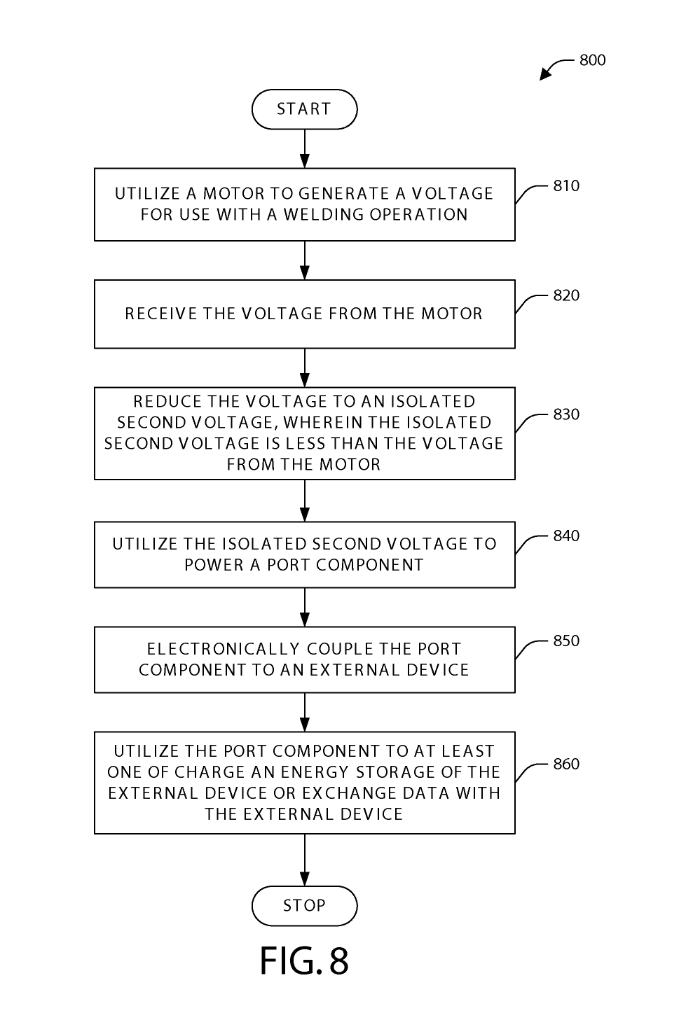

In view of the exemplary devices and elements described supra, methodologies that may be implemented in accordance with the disclosed subject matter will be better appreciated with reference to the flow charts and/or methodologies of FIG. 8. The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

Sequentially, the following occurs as illustrated in the decision tree flow diagram 800 of FIG. 8 which is flow diagram 800 that converts a voltage from a motor associated with an engine driven welder for use with a port component. For instance, a port component can be incorporated with an engine driven welder or welding device, wherein the port component is configured for at least one of a power source for an external device from the welding device or a data exchange between the external device and the welding device. A motor can be utilized to generate a voltage for use with a welding operation (reference block 810). The voltage can be received from the motor (reference block 820). The voltage can be reduced to an isolated second voltage, wherein the isolated second voltage is less than the voltage from the motor (reference block 830). The isolated second voltage can be utilized to power a port component (reference block 840). The port component can be electronically coupled to an external device (reference block 850). The port component can be utilized to at least one of charge an energy storage device of the external device or exchange data with the external device (reference block 860).

In an embodiment, the external device is at least one of a smartphone, a cellular device, a cellular phone, a tablet, a laptop, a portable digital assistant (PDA), an Internet browsing device, a Wireless Fidelity (Wi-Fi) device, or a device with a processor and memory. In an embodiment, a method can include at least the following steps: utilizing an energy storage device to generate a supplemental voltage for use with the welding operation; converting the supplemental voltage to an isolated third voltage; and utilizing the isolated third voltage to power the port component.

In an embodiment, the method can include reducing the voltage from the motor to power the port component or reducing the supplemental voltage from the energy storage device to power the port component. In an embodiment, a method can include at least the following steps: transmitting a first set of data to the external device, wherein the first set of data is related to a condition of the welding device; receiving a second set of data from the external device, wherein the second set of data is based upon the first set of data and relates to improving the condition of the welding device; and displaying a set of instructions that are representative of the second set of data.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding device, comprising:
a motor-driven welder assembly including a motor that is a power source for the welding device to perform a welding operation;
a first circuit that electrically isolates and converts the power source to a first voltage used for controlling the welding operation;
a port component that electrically isolates and converts the first voltage to a second voltage, wherein the second voltage is used as at least one of a power source for an external device or a power source to provide data communication between a portion of the welding device and the external device.

2. The welding device of claim 1, further comprising:
an energy storage device that is an additional power source for the welding device to perform the welding operation; and
a switch component that selects between the energy storage device and the motor.

3. The welding device of claim 2, further comprising the port component electrically isolates and converts the additional power source to the second voltage.

4. The welding device of claim 1, wherein the port component is a female connector that is configured to receive a male connector for the external device to provide electrical connectivity therebetween for at least one of power exchange or data communication.

5. The welding device of claim 1, further comprising the port component provides the second voltage to an energy storage device of the external device.

6. The welding device of claim 1, wherein the port component is at least one of a Universal Serial Bus (USB) port, a Controller Area Network (CAN) bus, a wireless communication transmitter, a wireless communication receiver, a 12-volt charger port, a 9-volt charger port, a micro USB port, a mini USB port, a micro-A USB port, a micro-B USB port, a mini-A USB port, a mini-B USB port, a type A USB port, or a type B USB port.

7. The welding device of claim 1, wherein the first voltage is between 35 volts and 45 volts and the second voltage is between 4 volts and 14 volts.

8. The welding device of claim 7, wherein the first voltage is approximately 40 volts and the second voltage is approximately 5 volts, 9 volts or 12 volts.

9. The welding device of claim 7, wherein the first voltage is approximately 12 volts and the second voltage is approximately 5 volts or 9 volts.

10. The welding device of claim 1, further comprising a diagnostic component that communicates with the external device to at least one of receive or transmit a portion of data related to a condition of the welding device.

11. The welding device of claim 10, wherein the diagnostic component communicates with a portion of software hosted by the external device.

12. The welding device of claim 11, wherein the diagnostic component generates an instruction, that is based on the portion of data, to mitigate the condition of the welding device.

13. The welding device of claim 12, wherein the instruction is at least one of a user input on the welding device, an adjustment to a setting on the welding device, a restart of the motor of the welding device, an adjustment to a fluid related to the motor of the welding device, a maintenance on the welding device, or a replacement of a component of the welding device.

14. The welding device of claim 1, wherein the external device is at least one of a smartphone, a cellular device, a cellular phone, a tablet, a laptop, a portable digital assistant (PDA), an Internet browsing device, a Wireless Fidelity (Wi-Fi) device, or a device with a processor and memory.

15. A method for a welding device, comprising:
utilizing a motor to generate a voltage for use with a welding operation;
receiving the voltage from the motor;
reducing the voltage to an isolated second voltage, wherein the isolated second voltage is less than the voltage from the motor;
utilizing the isolated second voltage to power a port component;
electronically coupling the port component to an external device; and
utilizing the port component to at least one of charge an energy storage device of the external device or exchange data with the external device.

16. The method of claim 15, wherein the external device is at least one of a smartphone, a cellular device, a cellular phone, a tablet, a laptop, a portable digital assistant (PDA), an Internet browsing device, a Wireless Fidelity (Wi-Fi) device, or a device with a processor and memory.

17. The method of claim 15, further comprising:
utilizing an energy storage device to generate a supplemental voltage for use with the welding operation;
converting the supplemental voltage to an isolated third voltage; and
utilizing the isolated third voltage to power the port component.

18. The method of claim 17, further comprising reducing the voltage from the motor to power the port component or reducing the supplemental voltage from the energy storage device to power the port component.

19. The method of claim 15, further comprising:
transmitting a first set of data to the external device, wherein the first set of data is related to a condition of the welding device;
receiving a second set of data from the external device, wherein the second set of data is based upon the first set of data and relates to improving the condition of the welding device; and
displaying a set of instructions that are representative of the second set of data.

20. A welding device, comprising:
a motor-driven welder assembly including a motor that is a power source for the welding device to perform a welding operation;
an energy storage device that provides a supplemental power source to the power source to perform the welding operation;
a switch component that is configured to automatically switch between the motor and the energy storage device to perform the welding operation based on a welding parameter;
a first circuit that electrically isolates and converts the power source or the supplemental power source to a first voltage used for controlling the welding operation;
means for connecting a smartphone to the welding device; and
a port component that electrically isolates and converts the first voltage to a second voltage, wherein the second voltage is used as at least one of a power source for the smartphone or a power source to provide data communication between a portion of the welding device and the smartphone.
